(19) United States
(12) Patent Application Publication
(10) Pub. No.: US 2022/0236360 A1
(43) Pub. Date: Jul. 28, 2022

(54) METHOD AND SYSTEM OF DETECTION OF ACOUSTIC SOURCE AIMING DIRECTION

(71) Applicant: Intel Corporation, Santa Clara, CA (US)

(72) Inventors: Hector Alfonso Cordourier Maruri, Guadalajara (MX); Sandra Elizabeth Coello Chavarin, Zapopan (MX); Diego Mauricio Cortes Hernandez, Zapopan (MX); Rosa Jacqueline Sanchez Mesa, Zapopan (MX); Jose Rodrigo Camacho Perez, Guadalajara (MX); Paulo Lopez Meyer, Zapopan (MX); Julio Cesar Zamora Esquivel, Sacramento, CA (US); Alejandro Ibarra Von Borstel, Manchaca, TX (US); Jose Israel Torres Ortega, Zapopan (MX); Miguel Angel Tlaxcalteco Matus, Tlaquepaque (MX)

(73) Assignee: Intel Corporation, Santa Clara, CA (US)

(21) Appl. No.: 17/724,332

(22) Filed: Apr. 19, 2022

(51) Int. Cl. G01S 3/808; H04R 3/00

(52) U.S. Cl. CPC G01S 3/8083; H04R 2430/20; H04R 3/005

(57) ABSTRACT

A system, article, and method of detection of acoustic source aiming direction uses multiple microphones.

### BACKGROUND

A number of audio computer applications analyze a human voice such as automatic speech recognition (ASR) that identifies the words being spoken or speaker recognition (SR) that can identify which person is speaking. For these audio applications, it is often desirable to know the location of an acoustic source relative to an audio receiving or listening device with microphones. This acoustic source detection, also referred to as acoustic angle of arrival (AoA) detection, may assist communication devices, such as on a smartphone or smart speaker for example, to differentiate an intended user from other acoustic sources of interference in the background, determine the context or environment around the audio source, and/or enhance audio transmissions or quality.

While such AoA detection determines the position of an audio source relative to a listening device, or in other words which direction or angle the sound is coming from relative to the position of the listening device, the listening device cannot determine which direction the audio source is emitting or aiming the sound relative to a position of the listening device. Thus, the conventional listening device may determine a position of a person who is speaking but still cannot determine if the person is facing the listening device. Usually, when a person is facing the listening device, it is more likely the person intends to awaken a personal assistant application on the listening device that responds with requested information or activates requested actions on the device. When a person is facing away from the listening device, it is much more likely the person does not intend to awaken the device. Without such knowledge to prevent the unintentional waking of the device, this may result in numerous annoying experiences with the device thereby drastically lowering the quality of user experiences while also wasting battery power stored on the listening device.

### DESCRIPTION OF THE FIGURES

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a schematic drawing of a setting of an acoustic environment with an audio source near a listening device;

FIG. 2A is a top view schematic diagram of an audio radiation pattern from a person speaking;

FIG. 2B is a schematic top view of an acoustic environment with an audio source aiming audio away from a listening device;

FIG. 3 is an angle chart showing aim and angle of arrival directions relative to the listening device of FIG. 2;

FIG. 4 a schematic top view of an acoustic environment with an audio source aiming audio toward a listening device;

FIG. 5 is an angle chart showing aim and angle of arrival directions relative to the listening device of FIG. 4;

FIG. 6 is a flow chart of an example method of detection of acoustic source aiming direction according to at least one of the implementations described herein;

FIG. 7 is a detailed flow chart of another example method of detection of acoustic source aiming direction according to at least one of the implementations described herein;

FIG. 8 is a schematic flow diagram illustrating an example method of detection of acoustic source aiming direction when a user is facing a listening device according to at least one of the implementations described herein;

FIG. 9 is a schematic flow diagram illustrating an example method of detection of acoustic source aiming direction when a user is not facing a listening device according to at least one of the implementations described herein;

FIG. 10 is a schematic flow diagram showing an example audio capture and audio signal processing with feature extraction according to at least one of the implementations herein;

FIG. 11 is a schematic diagram of an example direction classifying neural network used in the methods of audio processing according to at least one of the implementations herein;

FIG. 12A is a schematic diagram of a system for audio aiming detection used in the methods of audio processing according to at least one of the implementations herein;

FIG. 12B is another schematic diagram of a system for audio aiming detection used in the methods of audio processing according to at least one of the implementations herein;

FIG. 13 is a schematic diagram of a neural network used in the methods of audio processing according to at least one of the implementations herein;

FIG. 14 is a flow chart of a method of training a neural network used in the methods of audio processing according to at least one of the implementations herein;

FIGS. 15A-15B are images showing audio environment setups for testing the methods of audio processing according to at least one of the implementations herein;

FIG. 16 is a chart showing a test confusion matrix with results of testing used with FIGS. 15A-15B and the methods of audio processing according to at least one of the implementations herein;

FIGS. 17A-17I are images showing more audio environment setups for testing the methods of audio processing according to at least one of the implementations herein;

FIG. 18 is a chart showing another test confusion matrix with results of testing a facing/not facing determination using the setups of FIGS. 17A-17I and the methods of audio processing according to at least one of the implementations herein;

FIG. 19 is a receiver operating characteristic chart of testing results used with FIG. 18;

FIG. 20 is yet another chart showing yet another test confusion matrix with results of testing for specific angles using the setups of FIGS. 17A-17I and the methods of audio processing according to at least one of the implementations herein;

FIG. 21 is a receiver operating characteristic chart of testing results used with FIG. 20;

FIG. 22 is an illustrative diagram of an example system;

FIG. 23 is an illustrative diagram of another example system; and

FIG. 24 illustrates another example device, all arranged in accordance with at least some implementations of the present disclosure.

### DETAILED DESCRIPTION

One or more implementations are now described with reference to the enclosed figures. While specific configurations and arrangements are discussed, it should be understood that this is performed for illustrative purposes only. Persons skilled in the relevant art will recognize that other configurations and arrangements may be employed without departing from the spirit and scope of the description. It will be apparent to those skilled in the relevant art that techniques and/or arrangements described herein also may be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes unless the context mentions specific structure. For instance, various architectures employing, for example, multiple integrated circuit (IC) chips and/or packages, and/or various computing devices and/or consumer electronic (CE) devices such as laptop or desktop computers, tablets, mobile devices such as smart phones or smart speakers, video game panels or consoles, high definition audio systems, surround sound or neural surround home theatres, television set top boxes, on-board vehicle systems, dictation machines, security and environment control systems for buildings, and so forth, may implement the techniques and/or arrangements described herein. Further, while the following description may set forth numerous specific details such as logic implementations, types and interrelationships of system components, logic partitioning/integration choices, and so forth, claimed subject matter may be practiced without such specific details. In other instances, some material such as, for example, control structures and full software instruction sequences, may not be shown in detail in order not to obscure the material disclosed herein. The material disclosed herein may be implemented in hardware, firmware, software, or any combination thereof.

The material disclosed herein also may be implemented as instructions stored on a machine-readable medium or memory, which may be read and executed by one or more processors. A machine-readable medium may include any medium and/or mechanism for storing or transmitting information in a form readable by a machine (for example, a computing device). For example, a machine-readable medium may include read-only memory (ROM); random access memory (RAM); magnetic disk storage media; optical storage media; flash memory devices; electrical, optical, acoustical or other forms of propagated signals (e.g., carrier waves, infrared signals, digital signals, and so forth), and others. In another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as RAM and so forth.

References in the specification to “one implementation”, “an implementation”, “an example implementation”, and so forth, indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described herein.

Systems, articles, and methods of detection of acoustic source aiming direction are described herein.

For some computer applications that require human to machine interaction (HMI) based on voice and/or speech, some devices have added microphone arrays to allow detection of the voice Angle of Arrival (AoA) and enable further speech enhancement techniques such as beamforming or blind source separation (BSS). As mentioned, however, AoA detection cannot, by itself, establish whether or not a user is originally aiming their voice towards a listening device and intends to awaken the device. Also, AoA alone cannot detect face orientations when such is desired.

In some case, and in order to determine whether or not a person is facing their audio listening device, image recognition pipelines could be used. Thus, cameras with added image recognition algorithms can be used to detect human user faces and determine if a user is talking towards a listening device rather than another person or other object. This can be accomplished by estimating the person's face orientation during a spoken interaction.

Such image recognition, however, requires expensive cameras, especially for full 360° detection that may require multiple or specialized cameras. Also, image recognition algorithms that can estimate facial orientation usually produce a high computer overhead (computational load and power consumption). Moreover, the image analysis often cannot be directly assessed from pure optical observation when multiple people are present and one of the people are directing their speech toward the listening device. In these cases, the image analysis would need to detect which person is speaking. For instance, tracking of mouth movement or lip reading could be used. However, mouth movements can sometimes be confused in the presence of multiple users. Thus, an expensive multi-modal detection solution would need to be used. Also, such systems will still have a difficulty differentiating lip reading or lip-activity when some people are moving their mouths for different reasons, such as eating.

Otherwise, usage of specific key words received from a user such as “Alexa”, “Ski”, or “Cortana” can indicate the assumption that the user intends to be speaking to the listening device regardless of the speaker's face orientation. Keywords, however, can be used for other purposes, sometimes as part of normal conversation, such as when a person's name is, or is close to, “Alexa”, or otherwise can awaken the listening device due to false positives. Also, if multiple smart devices are in proximity, the use of keywords themselves cannot differentiate which device is the one being spoken to.

To resolve these issues, the method and system described herein uses sound pattern detection to detect whether or not a person is directing or aiming their voice towards a listening device equipped with a microphone array for example, and without the need of additional sensors or use of keywords. Knowing the direction of the emitted audio can provide additional context on how a user is trying to interface with a speech recognition system. Also, this can help to better discriminate if a user intends to awaken or command the listening device with their voice in a more natural way than just using the keywords.

This is accomplished by comparing the audio signals from different microphone pairs in a microphone array, which may be a circular array, to estimate small differences in the radiation of the sound pattern as features from the audio signals. Such circular arrays are already typically used for AoA detection and other reasons. This information allows the system to use a machine learning algorithm, such as a neural network, to estimate the aiming direction of the user's voice and determine whether the direction is towards the listening device or a different direction instead.

By one example, this arrangement provides a lightweight algorithm that does not require fast Fourier transform (FFT) or any other numeric transform, and with very simple feature extraction and classifier routines. No additional or specific function dedicated hardware is needed. By one form, no complex or sophisticated digital signal processor (DSP) or large machine learning (ML) model is needed either. This arrangement of a low power consumption algorithm enables always listening applications to use the disclosed methods.

The disclosed method presents an experimental accuracy of about 94% on detecting when a speaker is directing their voice towards a listening device. The disclosed system and method provides intelligent devices with a more natural mechanism for HMI by providing these devices an “awareness” when commands are directed towards the device.

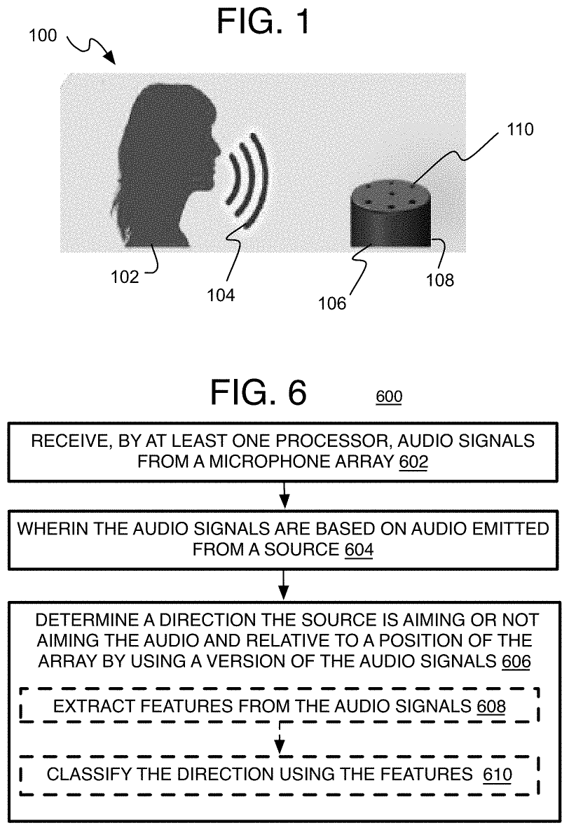

Referring to FIG. 1, an example acoustic environment or setting 100 is shown to assist with explaining the audio aiming direction detection system and methods described herein. The acoustic environment 100 includes a user 102 that is speaking and emitting acoustic waves 104 into the air, a microphone array 106 (whether on a computing device 108 or remotely coupled to a computing device) is spaced a distance from the user 102 and has a surface with openings to seven microphones 110 arranged in a circle and each forming an audio signal (or data) channel. The microphones 110 sense the acoustic waves 104 from the user 102. While the microphone array 106 is shown with seven microphones 110, more or less microphones may be used, and by one form, at least three microphones, and by one form arranged in a circle or triangle.

The microphone array 106 may be on a device 108 such as a smart speaker, and in this case, the computer components and modules, including the software, hardware, and/or firmware used to operate the disclosed aiming direction detection method may be physically located in the body of the computing device 108. Otherwise, the device 108 may only be a microphone array device, and the processing of the audio signals from the microphones and for the aiming direction detection method is performed on a remote device, whether wireless or wired, that is in communication with the device 108.

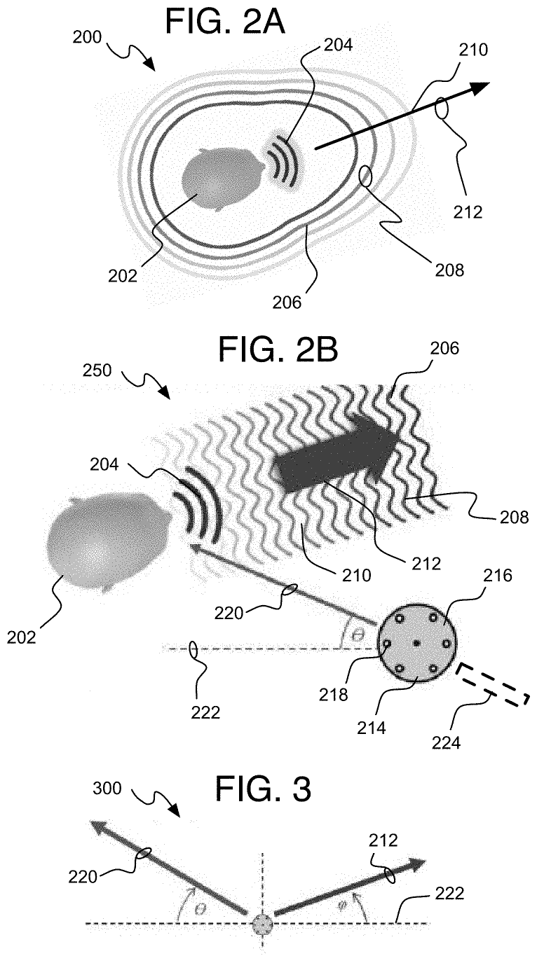

Referring to FIG. 2A, an audio source occurrence 200 has an acoustic source here being a user or person 202. Specifically, the user's head or mouth is used for speaking or emitting sounds in the form of sound waves 204, and the sound waves typically have a shape of an audio radiation pattern 206 with generally oval or egg-shaped waves 208 radiating outward from the user 202 in top view as shown. This radiation pattern 206 is uneven due to human physical features and the fact that the voice audio vibrations come principally from the mouth. This results in a clear maximum audio intensity point or area 210 extending outward and forward from the user's mouth. Thus, herein, the forward direction a person, and precisely the person's face, is facing as the person speaks (or otherwise forms sounds with their mouth) is considered the intentional aiming direction 212 of the audio coming from the user's mouth (whether the person is consciously or unconsciously facing a certain direction). It should be noted that the source could be animals or other sources that have an audio radiation pattern that is uneven and has a peak audio intensity in a single direction or single general area or direction.

Referring to FIG. 2B, an acoustic setting 250 has the audio occurrence 200 occurring in a vicinity of a listening device 214 where the aiming direction 212 is not pointed toward the listening device. The listening device 214 may have a circular microphone array 216 with seven microphones 218, although by one example form, at least three microphones are used and spread out along a circle such as when three microphones are at corners of an equilateral triangle. Many other configurations of microphone arrays may be used such as linear or spherical, and as long as at least three microphones are present for a full 360° detection. Additional microphones can, in practice, increase the precision and granularity of the angle detection. This is convenient for most use cases of smart spaces and/or vehicles. Otherwise, the microphones, and microphone array, are not limited to any specific type of microphones.

While the circular array 216 in the top view of FIG. 2B is a horizontal array and the angles and directions discussed herein refer to horizontal angles, it will be appreciated that an additional or alternative vertical circular array 224 (shown in top view) could be used to determine vertical directions or angles from the source 202. The vertical array 224 may or may not have the same configuration as microphone array 216. Otherwise, circular arrays may be placed at slants to horizontal to provide both or either horizontal and vertical components for audio analysis for example. Many variations are contemplated.

The source 202 is shown to be located at an angle of arrival (AoA) direction 220 that is an angle θ from a reference line 222 extending from the array 216, and by one form, extending from a center of a circular array 216. The AoA direction 220 does not extend in the same direction as the aiming direction 212 as shown on FIG. 3. Instead, the aiming direction is at an angle φ from the reference line 222 where angle φ is not limited to be the same as AoA angle θ.

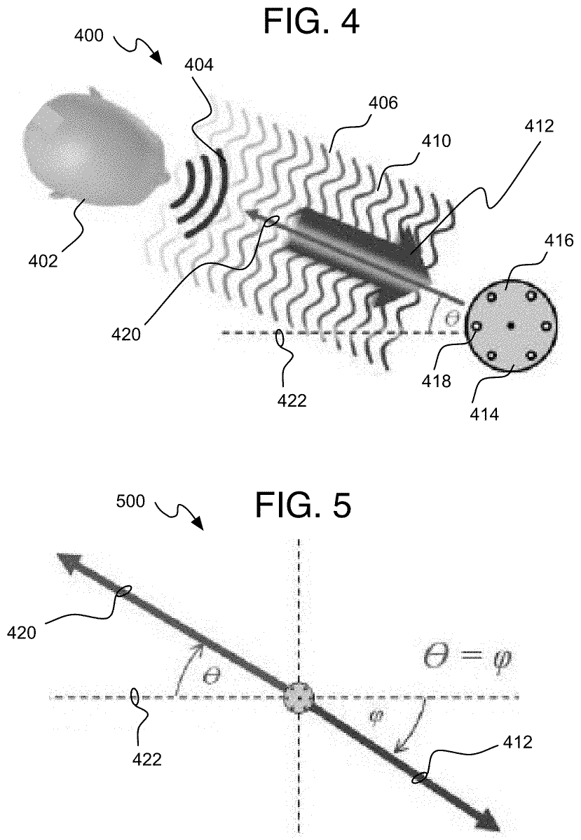

Referring to FIG. 4 for another example, an audio setting 400 has a source or user 402 emitting sound waves 404 forming a radiation pattern 406 with a peak audio intensity area 410 having an aiming direction 412 extending toward a listening device 414. The listening device 414 has a microphone array 416 with microphones 418. The user 402 is found to be located at an AoA direction 420 at an AoA angle θ that is between the AoA direction 420 and a reference line 422. In this case, however, the user 402 is facing toward the array 416 so that the aiming direction 412 is the same as, or parallel to, the AoA direction 412, and the aiming direction angle φ is the same as AoA direction angle θ (albeit shown in opposite directions) as shown on FIG. 5.

Since the aiming direction is not fixed for any particular positions of the source relative to the position of the array, the radiation pattern, and in turn audio intensities, will be different for the audio captured at each microphone of the array and depending on the aiming direction. This is in addition to any variations in AoA and distance between the source and the array. In turn, the sound amplitude (or frequencies) of audio received at each microphone 418 (or 218) of the array 416 (or 216) will be slightly different if the user's head is facing towards the device or away from it. This difference in the radiation patterns can be detected by comparing the audio signal amplitudes of the whole range of frequencies, or at certain frequencies or frequency bands, of different microphones on the array, and the differences (or more precisely a group of differences) can be classified to determine the acoustic source aiming direction.

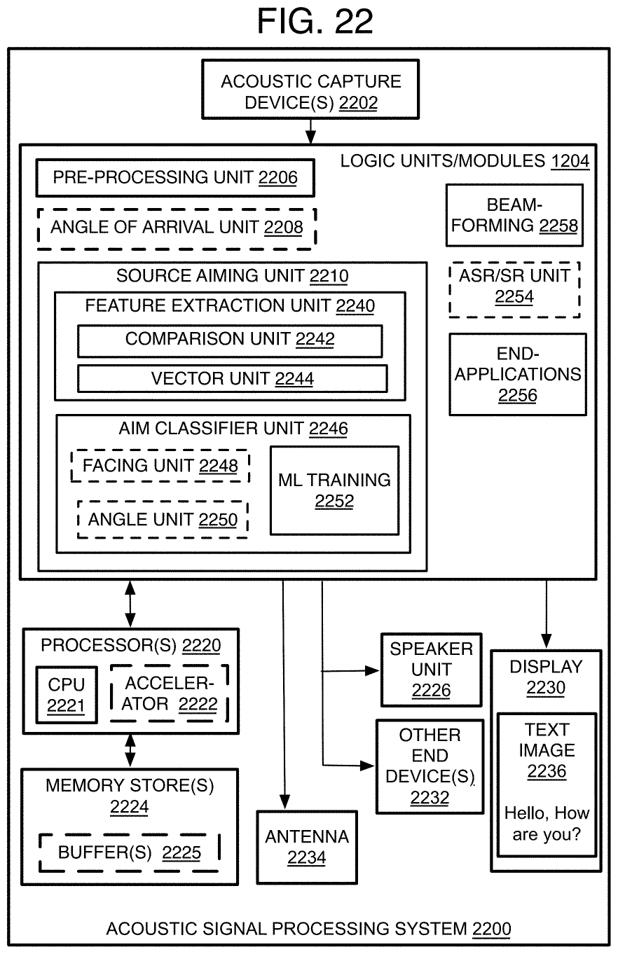

Referring to FIG. 6, an example process 600 for a computer-implemented method of detection of an acoustic source aiming direction is provided. In the illustrated implementation, process 600 may include one or more operations, functions or actions as illustrated by one or more of operations 602 to 610 numbered evenly. By way of non-limiting example, process 600 may be described herein with reference to example system 2200 described herein with FIG. 22, or any of the other systems, processes, or networks described herein, and where relevant.

Process 600 may include “receive, by at least one processor, audio signals from a microphone array” 602, and “wherein the audio signals are based on audio emitted from a source” 604. Thus, a source, such as a person, may be speaking or making other noises from their mouth, and the direction the person is facing while the person is emitting sound is the aiming direction of the audio being emitted and for the uneven audio radiation pattern as captured by the microphones of the array. The microphones then convert the captured audio, or audio waves, into audio signals which may include amplitudes in the whole frequency spectrum, or at specific frequencies or frequency bands, that correspond to audio intensity for example. The audio signals may remain in the time domain for the analysis herein (where the frequency domain or FFT is not needed). Also, the at least one processor may be a CPU, and no necessity exists for fixed function hardware, although such could be used when desired. The array may have at least three microphones and may be in any efficient or adequate arrangement although a circular array has been found to be adequate herein. Also, as mentioned, the array, or an additional array, could be vertical or slanted although a horizontal array is used herein.

Process 600 may include “determine a direction the source is aiming or not aiming the audio and relative to a position of the array by using a version of the audio signals” 606. This may include “extract features from the audio signals” 608. The feature extraction may include obtaining audio signals and computing a version of the audio signals that can be used to compare to audio signals of other microphones. This may include obtaining root mean square (RMS) values of a sample of each audio signal. By one example, the RMS values, or other version, of each audio signal of the same time frame may be compared. By one form, a comparison value is determined for each available pair of microphones on the array, and this may include using a center microphone of the array. By another form, the comparison values are only of radially opposite microphone pairs, or nearest to radially opposite. The comparison values of a same time period are then grouped together by concatenating them into a feature vector.

Process 600 may include “classify the direction using the features” 610, where here the feature vectors, or another form or version of the features, are input into a classifying machine language algorithm, which in one example, is a classifying neural network. Optionally, the neural network may provide outputs that determine or indicate whether or not the source is facing the array. This may be two outputs where one output provides a probability the aiming direction is toward the array and the other probability indicates whether the aiming direction is away from the array. By another alternative, a single binary output is used for the two possible outcomes. By another option, the neural network may determine an angle the source is facing relative to the array. Here, multiple output nodes may exist where each node corresponds to a specific angle (0 degrees, 45 degrees, and so forth), and the neural network outputs a probability of each angle. By one example, eight outputs are provided with an interval of 45 degrees, but many more or less could be used instead. Either of these neural networks may be used, or a single neural network may be used to output both kinds of data (facing decision output node(s) and specific angle output nodes).

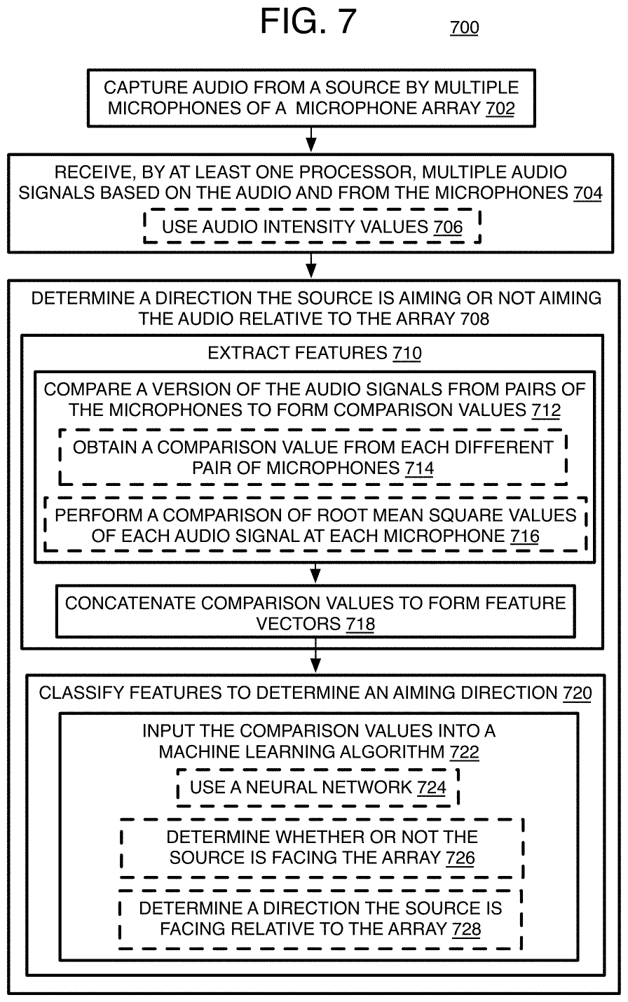

Referring to FIG. 7, an example detailed process 700 for a computer-implemented method of detection of an acoustic source aiming direction is provided. In the illustrated implementation, process 700 may include one or more operations, functions or actions as illustrated by one or more of operations 702 to 728 numbered evenly. By way of non-limiting example, process 700 may be described herein with reference to example system 2200 described herein with FIG. 22, or any of the other systems, processes, or networks described herein, and where relevant.

Process 700 may include “capture audio from a source by multiple microphones of a microphone array” 702, and as already mentioned with operation 602 of process 600.

Process 700 may include “receive, by at least one processor, multiple audio signals based on the audio and from the microphones” 704. Thus, as described above with process 600, each microphone senses acoustic waves that are converted into an audio signal on a separate channel so that each channel, here seven channels in an example microphone array, initially provides a raw audio signal. The audio signals then may be pre-processed such as by analog to digital (ADC) conversion, de-noising, dereverberation, and otherwise to convert the signals into versions of audio data or signals that can be used at least for acoustic source aiming direction detection, but also may be performed for other applications, such as AoA detection. Another operation that may or may not be considered as part of pre-processing is normalization of the audio signals from individual or each channel. By one form, L1 normalization may be applied but could be other forms of normalization such as L2 or simply dividing the maximum value by some constant, provided that all the channels are divided or multiplied by the same value simultaneously, and not each channel with its own reference value. By one form, pre-processing may be performed as long as all channels are treated with the same pre-processing to avoid unintentional introduction of greater channel differences that could influence the detection applications.

The audio signals may be provided as samples of the received audio each with a time frame. One segmented time frame of the audio signal may be obtained for each or individual microphones on the array, which results in one time frame sample per channel. By one example, the samples of the audio signals may have a duration of approximately 250 ms each at 16 kHz intervals, although other sampling rates may be used instead, and each set of samples obtained for the same time frame may be referred to herein as a frame. By one form, the present detection process needs the acoustic sources to remain relatively fixed within the acoustic environment while obtaining the samples in order to provide near real time analysis. Thus, the samples may be obtained for durations of at about or less than 250 ms by one form, but may be up to 500 ms by other forms. This has been found to be sufficiently close to real time (or near instantaneous) relative to the motion and speech of a typical human. While this may not be considered precisely instantaneous, it is still reasonable for most audio and/or speech purposes in which audio aiming detection is computed relatively sparsely in time (which is much less than an AoA detection rate typically needed for radio frequency (RF) applications for example). This increase in sample duration (or time frame length), and in turn, reduction in total feature extraction speed to provide input features to a classifier (or sample duration or time frame length) is one of the reasons that enables the present system to be particularly lightweight.

This duration of the sample is referred to as a time frame herein such that samples obtained from different channels at substantially the same time frame are considered samples of the same time. Those time frames with different start and/or end points are considered samples from different time frames, even though such time frames could overlap. While the methods herein disclose comparing samples of the same time frame to form comparison values or features, by another alternative, samples from different time frames, alone or in addition to samples of the same time frame, could also be collected in a feature vector to train a machine learning algorithm to determine the aiming direction. This could be some number of consecutive samples for each microphone in the array that is placed into a single feature vector, as one possible example.

By yet another option, microphone pairs which have an axis perpendicular or at least closer to perpendicular to the detected AoA versus other microphone pairs could be considered preferential for the correct aiming direction detections when restricting or prioritizing microphone pairs is necessary or required.

Process 700 may include “use audio intensity values” 706, where the audio signals are audio intensity signals, although other audio parameters could be used. Herein, the amplitude values of the audio are used as the audio signals, while amplitude at different frequencies or frequency bands could be used instead.

Also as mentioned, the at least one processor mentioned above may be a CPU formed of processor circuitry as described herein, such that specific function processors are not required but could be used as desired.

Once the audio signals (or samples) are obtained from the microphones, process 700 may include “determine a direction the source is aiming or not aiming the audio and relative to the array” 708. This may include “extract features” 710. To accomplish the extraction, process 700 may include “compare a version of the audio signals from pairs of the microphones to form comparison values” 712. Since the audio signal of one microphone is provided in samples with a time frame, a representative audio signal value from that time frame is obtained for the comparisons to audio signals of other microphones. This may include a single obtained value from the sample, such as a certain point in the sample (first, middle, or last for example).

Instead, however, and as used herein, a more accurate reading is obtained by combining the values in the sample, and by the example used herein, by use of a root mean square (RMS) of the audio signal values in a single sample with a time frame. The RMS amplitude from each of them is calculated for each or individual audio signal sample, and for each or individual microphone on the array. By yet another alternative, no representative value is used for a sample, and values, such as amplitudes, of two audio signals samples are compared directly as described below.

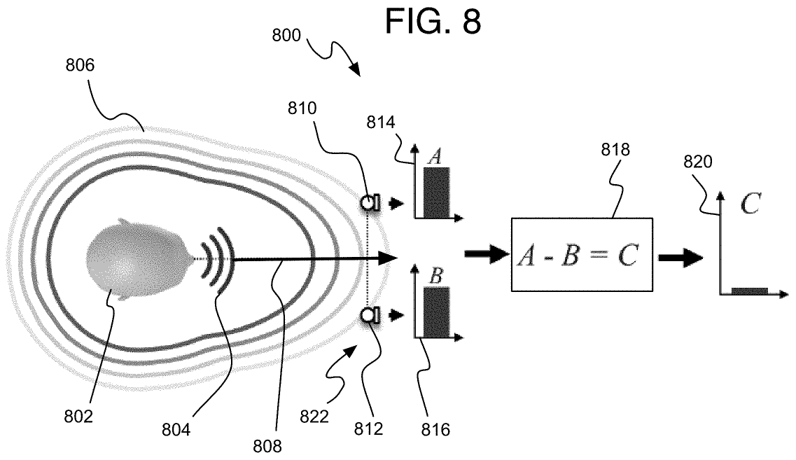

Referring to FIG. 8, a process 800 depicts the generation of the comparison values and is used to explain process 700. Process 800 shows a source 802 being a person emitting sound (or sound waves) 804 in an audio or sound radiation pattern 806 as the person speaks. In this example, the person 802 is facing a microphone array 822 and the audio radiation pattern 806 has an aiming direction 808 of peak audio intensity extending toward and midway (or evenly) between two microphones 810 and 812 on the microphone array 822. In other alternatives, the aiming direction 808 facing the array 822 may be directed precisely to a single microphone on the array 822 or could be closer to one microphone than another on the array 822 depending on the orientation of a listening device with the array 822. It will be understood that the precise microphone arrangement of the array 822 relative to the aiming direction 808 should not significantly affect the final output with a circular array (discounting manufacturing tolerances) since the microphones have a fixed position on the device, and the direction facing or toward the array will be set or defined for a particular microphone arrangement of the array 822.

As shown, both microphones 810 and 812 may provide raw audio signals in the form of the samples with a same time frame. RMS amplitude values A and B respectively may be computed for each microphone 810 and 812, or channel, or sample. As shown on RMS charts 814 and 816, the RMS values A and B are similar since the aiming direction 808 is midway between the microphones 810 and 812. The RMS values A and B are then ready to be compared to each other.

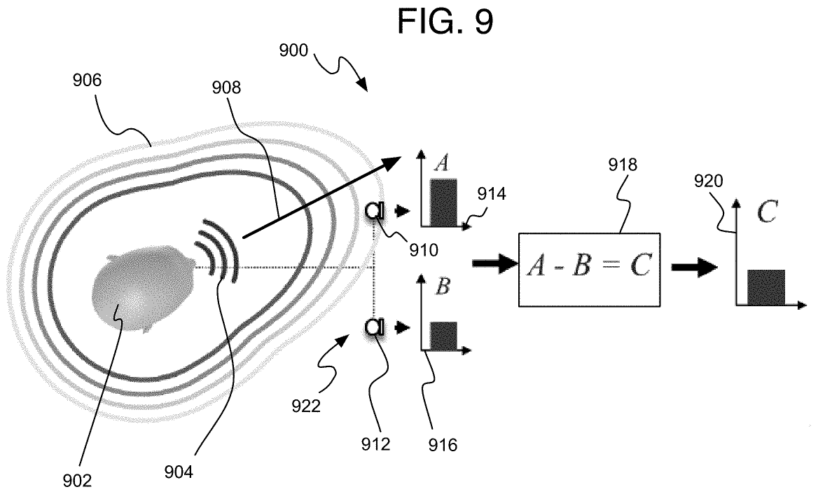

Referring to FIG. 9, a process 900 is similar to process 800 except now showing the source 902 aiming at an angle to microphones 910 and 912 on an array 922 so that an aiming direction 908 is to the left of microphone 910 rather than between the two microphones 910 and 912. In this case, the microphone 910 has a higher RMS value A than the RMS value B of the farther microphone 912 as shown on RMS charts 914 and 916. The other units or components of process 900 may be the same or similar to that of process 800 and numbered similarly to that of process 800.

Process 700 may include “obtain a comparison value from each different pair of microphones” 714, and this may include “perform a comparison of root mean square values of each audio signal at each microphone” 716. This involves obtaining the RMS amplitude difference from all or selected individual microphone pairs. This is shown by the subtraction equation 818 (FIG. 8) and 918 (FIG. 9) to compute a comparison value C. The comparison value C (on chart 820) is much smaller than comparison value C (chart 918) of computation 918 when the aiming direction 808 is directly midway between two microphones (and radially intersecting the array 822 as shown) versus the angled aiming direction 908 on process 900 that will provide much more audio intensity to one of the microphones 910 compared to the other microphone 912. These operations are repeated for each pair of microphones included to form comparison values as features of the audio signals. By an alternative example, the audio signal values (or amplitudes) of two samples of two microphones are compared directly, such as by subtraction, and an RMS is then computed for all differences of the audio signal values of the two samples and for a same time frame. The computation of the comparison value is repeated for each pair of microphones being analyzed.

Process 700 next may include “concatenate comparison values to form feature vectors” 718. The combination values are then placed in a feature vector for the detection of directed speech using a ML technique. This may include 21 comparison values (or features or elements) when a seven-microphone array is being used and all possible microphone pairs have a comparison value placed into the feature vector.

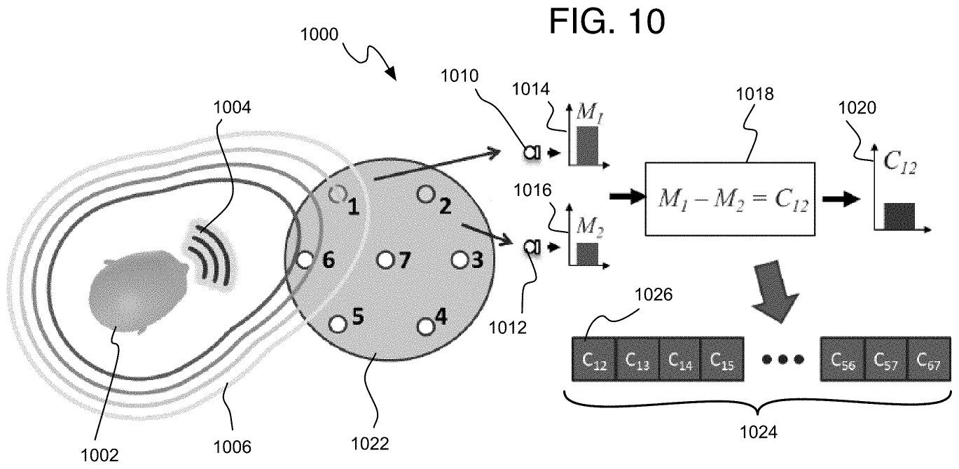

Referring to FIG. 10, a process 1000 is similar to that shown for processes 800 and 900 and has similar reference numbers for the same or similar operations or components. Here, however, a microphone array 1022 has microphones numbered 1 to 7. The process 1000 is comparing the audio signals from a pair of microphones including microphone 1 (1010) and microphone 2 (1012). Their RMS values, or other values, M₁ and M₂ that represent the audio signal from the microphones 1 and 2 are then compared (or subtracted) by the comparison equation 1018 to generate a comparison value C₁₂. The subscript ab indicates the two microphones used to form the comparison value. The comparison values Cab 1026 are then concatenated into a feature vector 1024. The comparison values 1026 could be combined and placed into the feature vector 1024 in a number of different ways, such as in a series, multidimensional matrices, or even tensors.

By one form, 21 comparison values are placed into a single feature vector when an array has seven microphones and a maximum of 21 different pairs of microphones can be used. It will be appreciated that the feature vector is formed of those elements simply by identifying those elements to be placed into a feature vector and does not necessarily need specific function memory to store or hold the feature vectors, although such a buffer could be used if desired.

Process 700 may include “classify features to determine an aiming direction” 720. Now, the process 700 uses the features, or feature vectors, to determine the aiming direction relative to the array. Thus, process 700 may include “input the comparison values into a machine learning algorithm” 722. Where the feature vectors may be fed to a machine learning (ML) classifier that is trained to distinguish between the cases in which speech is directed toward the array and when not directed toward the array. The term machine learning is used herein in its general sense to refer to the ability to at least learn during training, such as by adjusting neural network weights, and the learning is not necessarily during a run-time.

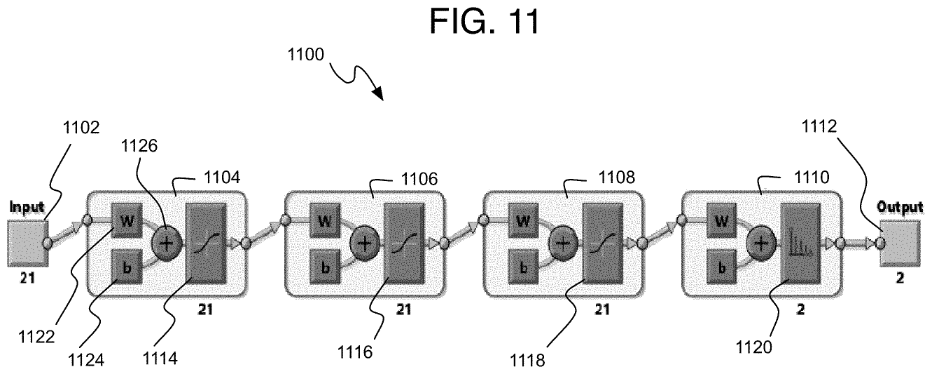

Referring to FIG. 11, by one example form, process 700 may include “use a neural network” 724, and as the machine learning classifier. By one example, a neural network 1100 is a 5-layer feedforward, fully connected network. A single input layer 1102 may be used with a linear activation function and by one form, receives the feature vector of 21 elements (21 neurons) each being a comparison value of a different pair of microphones. In the present network architecture, three hidden layers 1104, 1106, and 1108 may be used with sigmoid activation functions and remains with a layer size of 21 neurons each. Weights W and bias B are shown to be applied to the input of each layer before applying the activation function. One output layer 1110 may use a SoftMax activation function. The output or output node layer 1112 provides the determinations. By one form, the neural network may use floating double precision numbers, but variations may be used as well.

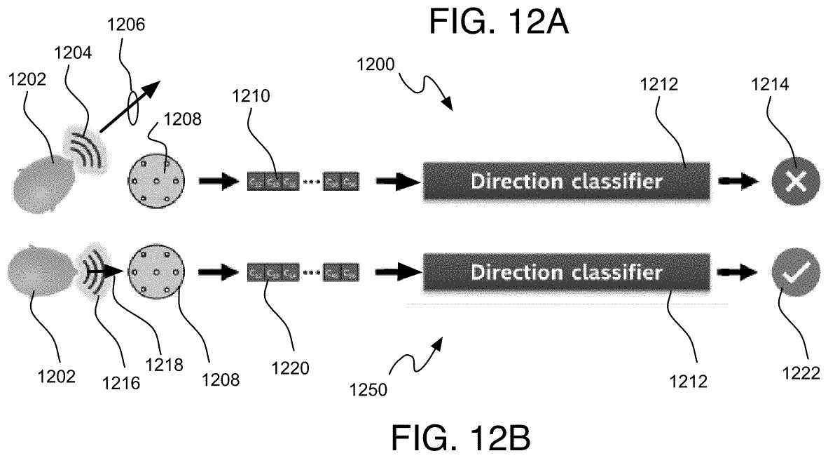

Referring to FIGS. 12A and 12B, and optionally, process 700 may include “determine whether or not the source is facing the array” 726. Systems 1200 and 1250 show this operation where a source 1202 directs sound waves 1204 or 1216 in an aiming direction 1206 or 1218. Aiming direction 1206 points away from a microphone array 1208. A resulting feature vector 1210 as described above is provided to a direction classifier (or ML algorithm or neural network) 1212, which generates a negative answer that the aiming direction 1206 is not facing or extending toward the array, and in turn a listening device, and at an output node 2014. This may be in form of a probability at a “not facing” output node layer 1214 of the neural network 1100 that has two nodes, one for a probability facing the array and another node for not facing the array. Otherwise, the output node layer 1214 may have a single node where if the probability is over a threshold, it refers to facing or not facing the array, and the opposite conclusion is reached if the output probability is less than the threshold. The system 1250 shows the same system as system 1200 except with a result of a positive determination at an output node 1222 that the aiming direction 1216 is toward the array 1208.

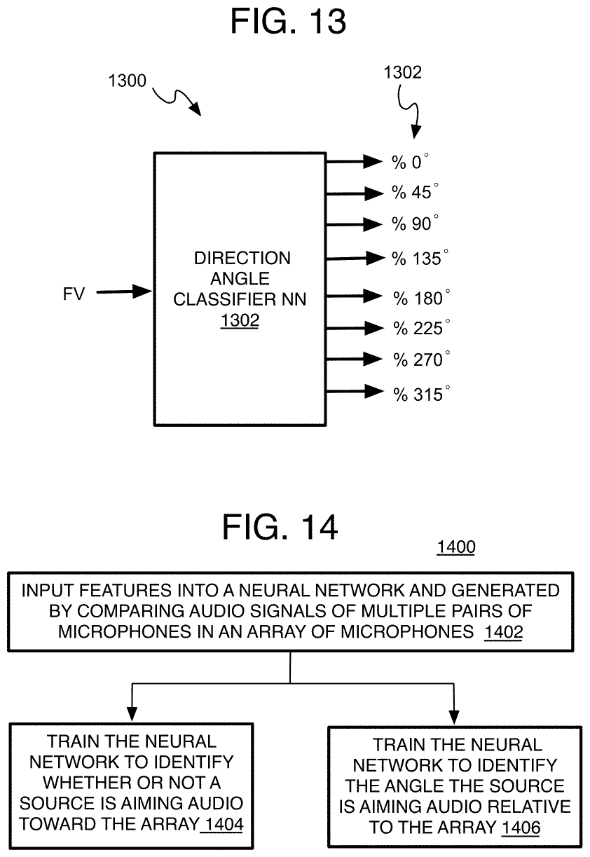

Referring to FIGS. 11 and 13, by another alternative, process 700 may include “determine a direction the source is facing relative to the array” 728. Here, the output layer 1110 and the output node layer 1112 may have multiple outputs with each output node being a class or probability that the aiming direction is at or near a specific angle relative to a reference line extending from the array, and by one form, extending from the center of the array. As shown on an example direction angle classifier neural network 1300, the neural network 1300 may receive feature vectors FV and may have an architecture the same or similar to that of neural network 1100. Here, however, eight outputs 1302 are shown each providing a probability of a different aiming direction from a reference line through the array, here being 0, 45, 90, 135, 180, 225, 270, and 315 degrees. The output with the highest probability is considered to be the angle. The reference line of the array may be fixed at some angle, such as 0 degrees, may be set relative to the microphone arrangement in the circular array, or may be set relative to the AoA, where the AoA line is always at 0 degrees relative to the source. Otherwise, the angles may be set to an external coordinate system, such as East always being 0 degrees. Also, one or more of these angle outputs may be considered to trigger the determination that the person is facing or not facing the listening device. By one form, this could be fixed at the 0 degree output node for example, but could also include the 45 degree and 315 (−45) degree nodes as well, and as mentioned above to include a range of angles to set as facing the array, and in turn the listening device, to factor in human behavior. Alternatively, a separate output node could be used as the facing/not facing determination node and is not limited to a specific angle.

It will be appreciated that the aiming direction also could be detected by having visual detection systems, such as with cameras and object detection and/or 3D depth or modeling applications, confirm the decision of the aiming direction detection.

Referring now to FIG. 14, an example computer-implemented process 1400 for training a neural network is provided. In the illustrated implementation, process 1400 may include one or more operations, functions or actions as illustrated by one or more of operations 1402 to 1406 numbered evenly. By way of non-limiting example, process 1400 may be described herein with reference to any of the systems or processes used herein, and where relevant.

Process 1400 may include “input features into a neural network and generated by comparing audio signals of multiple pairs of microphones in an array of microphones” 1402. For the training, the neural network is as described above with neural network 1100 and output features from systems 1200, 1250, and neural network 1300. By one form, the neural network was developed by using Matlab® but any development applications may be used.

Process 1400 may include “train the neural network to identify whether or not a source is aiming toward the array” 1404. Here, the neural network is simply trained to perform the facing/not facing (or directed/not directed) determination. The training may be supervised, and is performed by first obtaining audio samples at different source angles, distances, and locations relative to a circular microphone array of a listening device, and it is always known ahead of time when the signal is being aimed towards the device or not (such as by labeling). The environmental setting also may be varied, such as acoustic characteristics of rooms, room sizes, outdoors, and so forth.

In this case, and as mentioned above with the two opposite facing/not facing determinations, the neural network may be trained to recognize a range of angles that is considered to be facing the array or having the aiming direction extending toward the array or listening device. This may be a certain angle from when the aiming direction is pointed directly to the center of the array, such as within +/−5 to 45 degrees from the aiming direction pointing to the center of the array. Otherwise, the angle may be set to an edge of the array (to be tangent with a circle at the microphones at the circular array), or set to a tangent to an edge of the listening device. These may vary depending on the distance from the user to the listening device. The range of angles may be set at which ever results in the most accuracy during actual use of the aiming direction detection in light of actual human behavior while using the listening device. For instance, a person still may intend the awakening of the listening device when the person's mouth actually faces some maximum degrees to the side of the listening device.

Alternatively or additionally, process 1400 may include “train the neural network to identify the angle the source is aiming audio relative to the array” 1406. Here, the supervised learning would include training the neural network with a source or person facing known directions relative to a position of the microphone array, in different types of rooms, with different wall, floor and ceiling materials, with different typical background sounds for home or office environments.

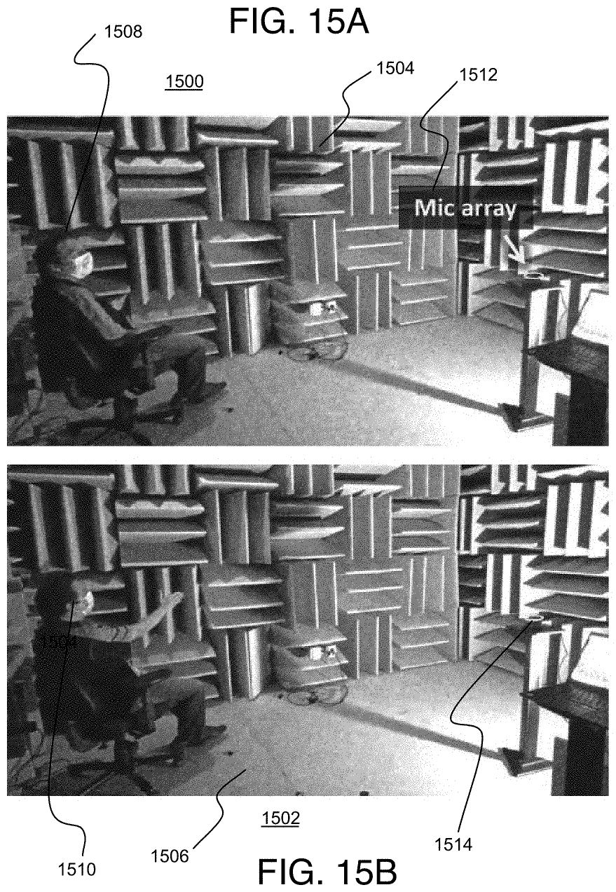

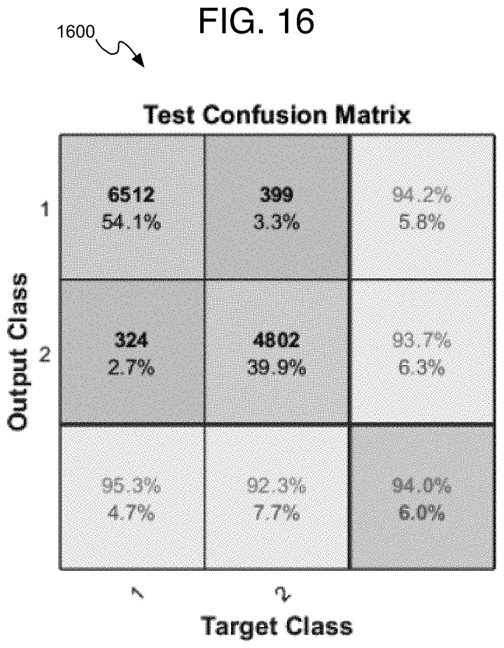

Referring to FIGS. 15A-16, feasibility tests were performed in a controlled anechoic chamber 1504 or 1506 of audio settings 1500 and 1502 respectively for two angles (0 and 40 degrees) and using real life audio recordings. Recordings were obtained with a circular 7-microphone array (UMA-8 USB mic array—V2.0) 1512 or 1514 in the anechoic chamber 1504 or 1506. The sample frequency used for the audio signals was 48 kHz. The test included recording three minutes of a human voice from a source 1508 sitting at 1.5 m from the microphone array 1512 and directed towards the device (FIG. 15A), and three minutes at the same distance and angle from the source 1510, but directed 40° away from the microphone array 1514 (FIG. 15B). From these recordings, 2.5 minutes were used for training, and 0.5 minutes (30 seconds) were reserved for testing resulting in 12037 samples that were tested.

To extract features, the features from the recorded audio samples were obtained using the disclosed methods of detection of the acoustic source aiming direction as described above and with a time frame of 250 ms. The classifier was a fully connected neural network (NN) as in FIG. 11 and that was trained and tested with the generated features. This NN used here has 21 elements (or inputs or input nodes) in the input layer, 21 elements in each of the three subsequent hidden layers (with sigmoid activation function) and two Softmax outputs at the output layer, representing two output classes: directed/not directed.

The correct classification results were measured based on an accuracy metric, and as shown on a confusion matrix 1600 (FIG. 16). The output (or predicted) class as a result of the disclosed method is on the left side or axis, while the target class (or actual aiming direction) is on the bottom or horizontal axis of the matrix. The ‘1’ row and column are the non-directed samples, and the ‘2’ row and column are the directed samples. The top number in the four upper left squares are the number of samples for each category, while the bottom number is the percentage of the total 12037 samples for that category. The right most column and bottom most row indicate the percentage correct over the percentage wrong for the category of the particular row or column indicated. The bottom left corner square indicates the total percentage correct over incorrect. The disclosed methods adequately detected the aiming direction of the audio from the source. Specifically, the results show 94.0% accuracy of correct direct and non-directed (non-facing) speech classification over the 30 second testing duration as can be seen in the lower right corner of the confusion matrix. This indicates the disclosed approach successfully detects when the speaker was and was not aiming their voice toward the device.

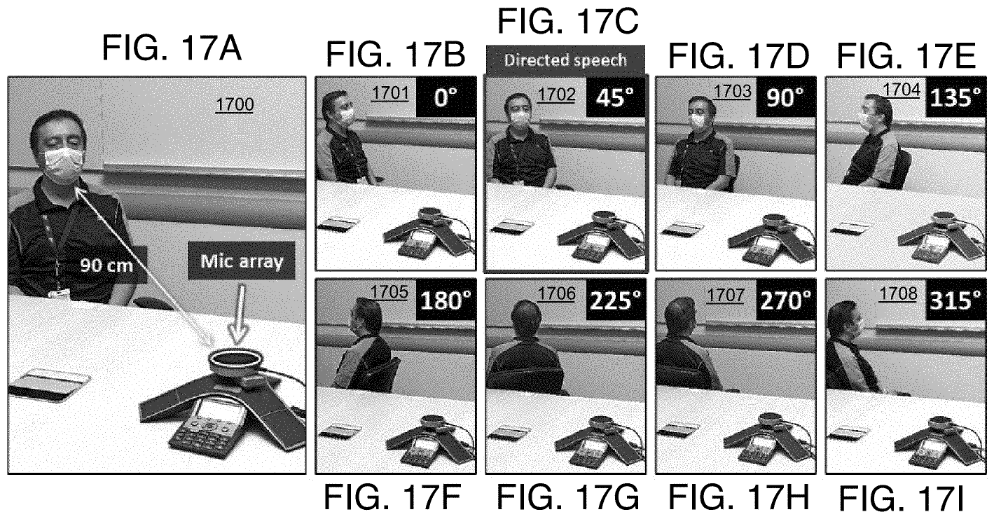

Referring to FIGS. 17A-17I, an additional feasibility test was performed to provide experiments closer to real world testing with a variety of angles through 90 degrees and up to 180 degrees and to determine how wall reflection may impact the results. Here, the audio setup is in a typical conference room as shown in images 1700-1708. In this setup, the circular array was situated in the middle of the room. The source test speaker was located at 90 cm from the array in a fixed angle set at 45° towards the array to establish an AoA and aiming direction towards the array. Care was taken to make sure the person's mouth was always centered in the same AoA direction angle with reference to the array in all recording sessions.

Recordings were made at eight different angles, encompassing 360° with 45° granularity, in which a two-minute voice sample was recorded per each angle as shown on images 1700 to 1708, where a total of 20,090 samples were tested for the facing/not facing determination and over 14000 samples were tested for specific angles. As shown on image 1702, the directed speech aimed at the array is at the 45 degree image 1702 and parallel to the pre-set AoA.

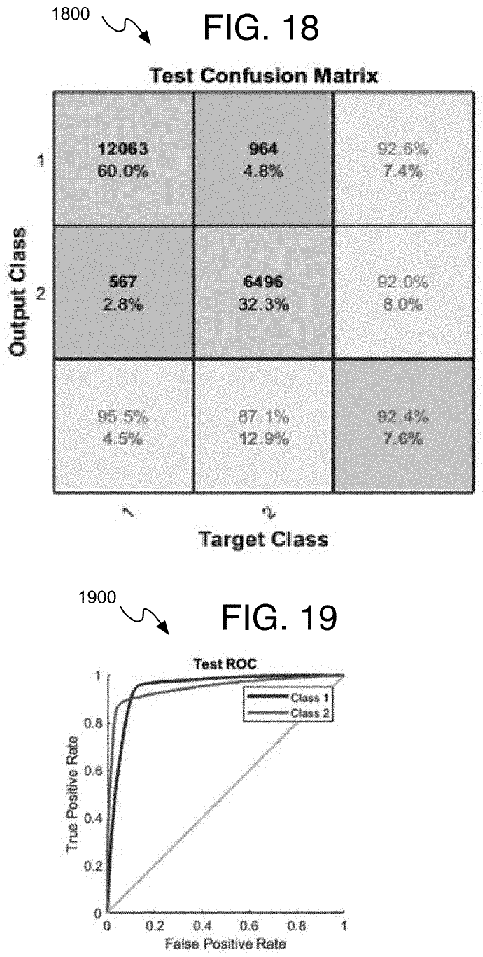

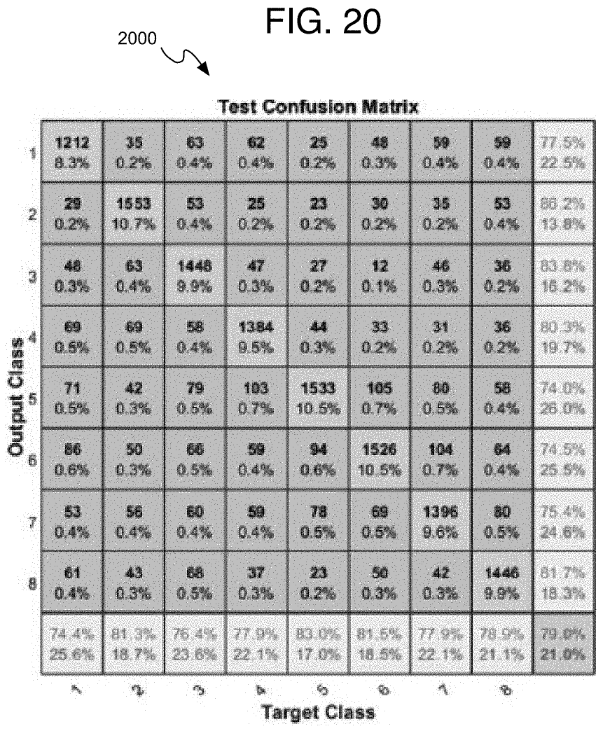

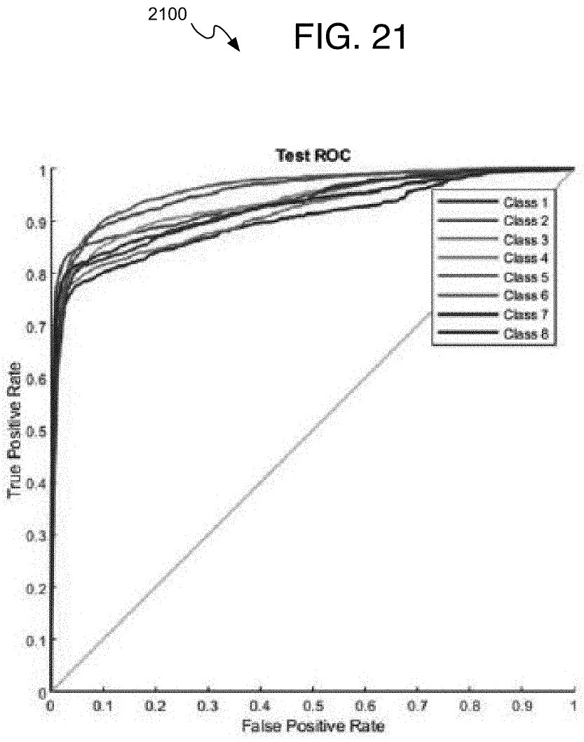

Once the recordings were generated, feature extraction was performed on the recordings with the same procedure described above with the previous tests, and such features were used to train the same light weight neural network classifier with the same architecture described in FIG. 11. The results of this classifier training for the testing samples used here (not included the training set) were performed for both a facing/not facing determination (FIGS. 18-19) and for specific angles (FIGS. 20-21) as follows.

Referring to FIGS. 18-19, as can be seen on a confusion matrix 1800, the neural network is able to correctly recognize between directed/not directed speech 92.4% of the time. Confusion matrix 1800 has a similar setup to that of confusion matrix 1600. It should be noted that in the former test with the anechoic chamber, the correct recognition rate was 94%. Here, with the testing in a typical indoor room with more reverberation than the anechoic chamber and with many more different aiming direction angles being tested, this reduced the correct accuracy rate by a mere 1.6%. A receiver operating characteristic chart 1900 has graph lines with shapes that easily indicate the high success rate where the true positive rate is much higher than the false positive rate. Thus, it can be concluded that the disclosed system and method maintains successful detection results for detecting the directing/non-directing (or facing/non facing) aiming direction even in challenging, real-life environments.

Referring to FIGS. 20-21, an additional test was performed by training the same neural network to output eight different output classes as shown in the images 1700-1708, with one output per each angle recorded. Referring to a confusion matrix 2000, the results indicate that the disclosed system and method still has significant success with detecting an aiming direction of a specific speech angle, and by correctly detecting the aiming direction at 79.0% of the time. The confusion matrix indicates the angle tested as numbered 1 to 8 which respectively corresponds to angles and images 1701 to 1708 as shown on FIGS. 17B-17I. A receiver operating characteristic chart 2100 confirms these results and shows the shape of the graph lines easily indicate the high success rate where the true positive rate is much higher than the false positive rate. Thus, the disclosed method can detect the aiming direction, and in turn speaker orientation relative to the array even in a moderately reverberant environments.

While implementation of the example processes 600, 700, 800, 900, 1000, and 1400 as well as systems 1200 and 1250 and networks 1100 and 1300, discussed herein may include the undertaking of all operations shown in the order illustrated, the present disclosure is not limited in this regard and, in various examples, implementation of the example processes herein may include only a subset of the operations shown, operations performed in a different order than illustrated, or additional or less operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the operations discussed herein and/or any portions the devices, systems, or any module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

As used in any implementation described herein, the term “logic unit” refers to any combination of firmware logic and/or hardware logic configured to provide the functionality described herein. The “hardware”, as used in any implementation described herein, may include, for example, singly or in any combination, hardwired circuitry, programmable circuitry, state machine circuitry, and/or firmware that stores instructions executed by programmable circuitry. The logic units may, collectively or individually, be embodied as circuitry that forms part of a larger system, for example, an integrated circuit (IC), system on-chip (SoC), and so forth. For example, a logic unit may be embodied in logic circuitry for the implementation firmware or hardware of the coding systems discussed herein. One of ordinary skill in the art will appreciate that operations performed by hardware and/or firmware may alternatively be implemented via software, which may be embodied as a software package, code and/or instruction set or instructions, and also appreciate that logic unit may also utilize a portion of software to implement its functionality.

As used in any implementation described herein, the term “component” may refer to a module or to a logic unit, as these terms are described above. Accordingly, the term “component” may refer to any combination of software logic, firmware logic, and/or hardware logic configured to provide the functionality described herein. For example, one of ordinary skill in the art will appreciate that operations performed by hardware and/or firmware may alternatively be implemented via a software module, which may be embodied as a software package, code and/or instruction set, and also appreciate that a logic unit may also utilize a portion of software to implement its functionality.

The terms “circuit” or “circuitry,” as used in any implementation herein, may comprise or form, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor (“processor circuitry”) and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other implementations may be implemented as software executed by a programmable control device. In such cases, the terms “circuit” or “circuitry” are intended to include a combination of software and hardware such as a programmable control device or a processor capable of executing the software. As described herein, various implementations may be implemented using hardware elements, software elements, or any combination thereof that form the circuits, circuitry, processor circuitry. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Referring to FIG. 22, an example acoustic signal processing system 2200 is arranged in accordance with at least some implementations of the present disclosure. In various implementations, the example acoustic signal processing system 2200 may have an acoustic capture device(s) 2202 to form or receive acoustical signal data. This can be implemented in various ways. Thus, in one form, the acoustic signal processing system 2200 is a device, or is on a device, with one or more microphones, or an array of microphones, such as a circular array. In other examples, the acoustic signal processing system 2200 may be in communication with one or an array or network of microphones, and may be remote from these acoustic signal capture devices such that logic modules 2204 may communicate remotely with, or otherwise may be communicatively coupled to, the microphones for further processing of the acoustic data.

In either case, such technology may include a smart phone, smart speaker, a tablet, laptop or other computer, dictation machine, other sound recording machine, a mobile device or an on-board device, or any combination of these. Thus, in one form, audio capture device 2202 may include audio capture hardware including one or more sensors as well as actuator controls. These controls may be part of a sensor module or component for operating the sensor. The sensor component may be part of the audio capture device 2202, or may be part of the logical modules 2204 or both. Such sensor component can be used to convert sound waves into an electrical acoustic signal. The audio capture device 2202 also may have an A/D converter, other filters, and so forth to provide a digital signal for acoustic signal processing.

In the illustrated example, the logic modules 2204 may include a pre-processing unit 2206 that may have an analog to digital convertor, and may perform other functions as mentioned above. The logic modules 2204 also optionally may have an angle of arrival (AoA) unit 2208 that performs the AoA detection mentioned above. To perform the aiming direction detection functions mentioned above, a source aiming unit 2210 may have a feature extraction unit 2240 with a comparison unit 2242 and a vector unit 2244 to form feature vectors. An aim classifier unit 2246 may have a facing unit 2248 that has a machine learning algorithm or neural network that determines whether or not a source is facing a listening device, or an angle unit 2250 that uses a neural network to determine an aiming direction angle, or both. The aim classifier unit 2246 also may have a machine learning training unit 2252 to train the classifier neural networks being used as described above. The logic modules 2204 also main include applications expecting output from the source aiming unit 2210, AoA unit 2208, or both such as a beam-forming unit 2258, an ASR/SR unit 2254, and/or other end applications 2256 that may be provided to analyze and otherwise use the audio signals received from the acoustic capture device 2202. The logic modules 2204 also may include other end devices 2232 such as a coder to encode the output signals for transmission or decode input signals when audio is received via transmission. These units may be used to perform the operations described above where relevant. The tasks performed by these units or components are indicated by their labels and may perform similar tasks as those units with similar labels as described above.

The acoustic signal processing system 2200 may have processor circuitry forming one or more processors 2220 which may include central processing unit (CPU) 2221 and/or one or more dedicated accelerators 2222 such as the Intel Atom, memory stores 2224 with one or more buffers 2225 to hold audio-related data such as samples or feature vectors described above, at least one speaker unit 2226 to emit audio based on the input acoustic signals, or responses thereto, when desired, one or more displays 2230 to provide images 2236 of text for example, as a visual response to the acoustic signals. The other end device(s) 2232 also may perform actions in response to the acoustic signal. In one example implementation, the acoustic signal processing system 2200 may have the at least one processor 2220 communicatively coupled to the acoustic capture device(s) 2202 (such as at least three microphones or a microphone array) and at least one memory 2224. An antenna 2234 may be provided to transmit data or relevant commands to other devices that may use the AoA output, or may receive audio for AoA detection. As illustrated, any of these components may be capable of communication with one another and/or communication with portions of logic modules 2204 and/or audio capture device 2202. Thus, processors 2220 may be communicatively coupled to the audio capture device 2202, the logic modules 2204, and the memory 2224 for operating those components.

While typically the label of the units or blocks on device 2200 at least indicates which functions are performed by that unit, a unit may perform additional functions or a mix of functions that are not all suggested by the unit label. Also, although acoustic signal processing system 2200, as shown in FIG. 22, may include one particular set of blocks or actions associated with particular components or modules, these blocks or actions may be associated with different components or modules than the particular component or module illustrated here,

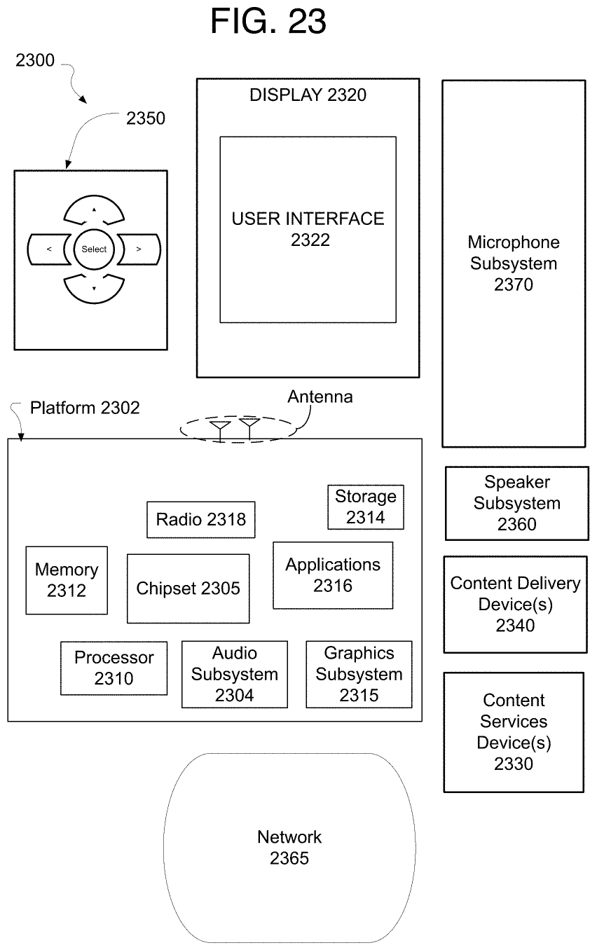

Referring to FIG. 23, an example system 2300 in accordance with the present disclosure operates one or more aspects of the speech processing system described herein. It will be understood from the nature of the system components described below that such components may be associated with, or used to operate, certain part or parts of the speech processing system described above. In various implementations, system 2300 may be a media system although system 2300 is not limited to this context. For example, system 2300 may be incorporated into multiple microphones of a network of microphones, personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth, but otherwise any device having a network of acoustic signal producing devices.

In various implementations, system 2300 includes a platform 2302 coupled to a display 2320. Platform 2302 may receive content from a content device such as content services device(s) 2330 or content delivery device(s) 2340 or other similar content sources. A navigation controller 2350 including one or more navigation features may be used to interact with, for example, platform 2302, speaker subsystem 2360, microphone subsystem 2370, and/or display 2320. Each of these components is described in greater detail below.

In various implementations, platform 2302 may include any combination of a chipset 2305, processor 2310, memory 2312, storage 2314, audio subsystem 2304, graphics subsystem 2315, applications 2316 and/or radio 2318. Chipset 2305 may provide intercommunication among processor 2310, memory 2312, storage 2314, audio subsystem 2304, graphics subsystem 2315, applications 2316 and/or radio 2318. For example, chipset 2305 may include a storage adapter (not depicted) capable of providing intercommunication with storage 2314.

Processor 2310 may be implemented as a Complex Instruction Set Computer (CISC) or Reduced Instruction Set Computer (RISC) processors; x86 instruction set compatible processors, multi-core, or any other microprocessor or central processing unit (CPU). In various implementations, processor 2310 may be dual-core processor(s), dual-core mobile processor(s), and so forth.

Memory 2312 may be implemented as a volatile memory device such as, but not limited to, a Random Access Memory (RAM), Dynamic Random Access Memory (DRAM), or Static RAM (SRAM).

Storage 2314 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 2314 may include technology to increase the storage performance enhanced protection for valuable digital media when multiple hard drives are included, for example.

Audio subsystem 2304 may perform processing of audio such as acoustic signals for one or more audio-based applications such as speech recognition, speaker recognition, and so forth. The audio subsystem 2304 may comprise one or more processing units, memories, and accelerators. Such an audio subsystem may be integrated into processor 2310 or chipset 2305. In some implementations, the audio subsystem 2304 may be a stand-alone card communicatively coupled to chipset 2305. An interface may be used to communicatively couple the audio subsystem 2304 to a speaker subsystem 2360, microphone subsystem 2370, and/or display 2320.

Graphics subsystem 2315 may perform processing of images such as still or video for display. Graphics subsystem 2315 may be a graphics processing unit (GPU) or a visual processing unit (VPU), for example. An analog or digital interface may be used to communicatively couple graphics subsystem 2315 and display 2320. For example, the interface may be any of a High-Definition Multimedia Interface, Display Port, wireless HDMI, and/or wireless HD compliant techniques. Graphics subsystem 2315 may be integrated into processor 2310 or chipset 2305. In some implementations, graphics subsystem 2315 may be a stand-alone card communicatively coupled to chipset 2305.

The audio processing techniques described herein may be implemented in various hardware architectures. For example, audio functionality may be integrated within a chipset. Alternatively, a discrete audio processor may be used. As still another implementation, the audio functions may be provided by a general purpose processor, including a multi-core processor. In further embodiments, the functions may be implemented in a consumer electronics device.

Radio 2318 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 2318 may operate in accordance with one or more applicable standards in any version.

In various implementations, display 2320 may include any television type monitor or display. Display 2320 may include, for example, a computer display screen, touch screen display, video monitor, television-like device, and/or a television. Display 2320 may be digital and/or analog. In various implementations, display 2320 may be a holographic display. Also, display 2320 may be a transparent surface that may receive a visual projection. Such projections may convey various forms of information, images, and/or objects. For example, such projections may be a visual overlay for a mobile augmented reality (MAR) application. Under the control of one or more software applications 2316, platform 2302 may display user interface 2322 on display 2320.

In various implementations, content services device(s) 2330 may be hosted by any national, international and/or independent service and thus accessible to platform 2302 via the Internet, for example. Content services device(s) 2330 may be coupled to platform 2302 and/or to display 2320, speaker subsystem 2360, and microphone subsystem 2370. Platform 2302 and/or content services device(s) 2330 may be coupled to a network 2365 to communicate (e.g., send and/or receive) media information to and from network 2365. Content delivery device(s) 2340 also may be coupled to platform 2302, speaker subsystem 2360, microphone subsystem 2370, and/or to display 2320.

In various implementations, content services device(s) 2330 may include a network of microphones, a cable television box, personal computer, network, telephone, Internet enabled devices or appliance capable of delivering digital information and/or content, and any other similar device capable of unidirectionally or bidirectionally communicating content between content providers and platform 2302 and speaker subsystem 2360, microphone subsystem 2370, and/or display 2320, via network 2365 or directly. It will be appreciated that the content may be communicated unidirectionally and/or bidirectionally to and from any one of the components in system 2300 and a content provider via network 2365. Examples of content may include any media information including, for example, video, music, medical and gaming information, and so forth.

Content services device(s) 2330 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 2302 may receive control signals from navigation controller 2350 having one or more navigation features. The navigation features of controller 2350 may be used to interact with user interface 2322, for example. In embodiments, navigation controller 2350 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures. The audio subsystem 2304 also may be used to control the motion of articles or selection of commands on the interface 2322.

Movements of the navigation features of controller 2350 may be replicated on a display (e.g., display 2320) by movements of a pointer, cursor, focus ring, or other visual indicators displayed on the display or by audio commands. For example, under the control of software applications 2316, the navigation features located on navigation controller 2350 may be mapped to virtual navigation features displayed on user interface 2322, for example. In embodiments, controller 2350 may not be a separate component but may be integrated into platform 2302, speaker subsystem 2360, microphone subsystem 2370, and/or display 2320. The present disclosure, however, is not limited to the elements or in the context shown or described herein.

In various implementations, drivers (not shown) may include technology to enable users to instantly turn on and off platform 2302 like a television with the touch of a button after initial boot-up, when enabled, for example, or by auditory command. Program logic may allow platform 2302 to stream content to media adaptors or other content services device(s) 2330 or content delivery device(s) 2340 even when the platform is turned “off.” In addition, chipset 2305 may include hardware and/or software support for 8.1 surround sound audio and/or high definition (7.1) surround sound audio, for example. Drivers may include an auditory or graphics driver for integrated auditory or graphics platforms. In embodiments, the auditory or graphics driver may comprise a peripheral component interconnect (PCI) Express graphics card.

In various implementations, any one or more of the components shown in system 2300 may be integrated. For example, platform 2302 and content services device(s) 2330 may be integrated, or platform 2302 and content delivery device(s) 2340 may be integrated, or platform 2302, content services device(s) 2330, and content delivery device(s) 2340 may be integrated, for example. In various embodiments, platform 2302, speaker subsystem 2360, microphone subsystem 2370, and/or display 2320 may be an integrated unit. Display 2320, speaker subsystem 2360, and/or microphone subsystem 2370 and content service device(s) 2330 may be integrated, or display 2320, speaker subsystem 2360, and/or microphone subsystem 2370 and content delivery device(s) 2340 may be integrated, for example. These examples are not meant to limit the present disclosure.

In various implementations, system 2300 may be implemented as a wireless system, a wired system, or a combination of both. When implemented as a wireless system, system 2300 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 2300 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 2302 may establish one or more logical or physical channels to communicate information. The information may include media information and control information. Media information may refer to any data representing content meant for a user. Examples of content may include, for example, data from a voice conversation, videoconference, streaming video and audio, electronic mail (“email”) message, voice mail message, alphanumeric symbols, graphics, image, video, audio, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The implementations, however, are not limited to the elements or in the context shown or described in FIG. 23.

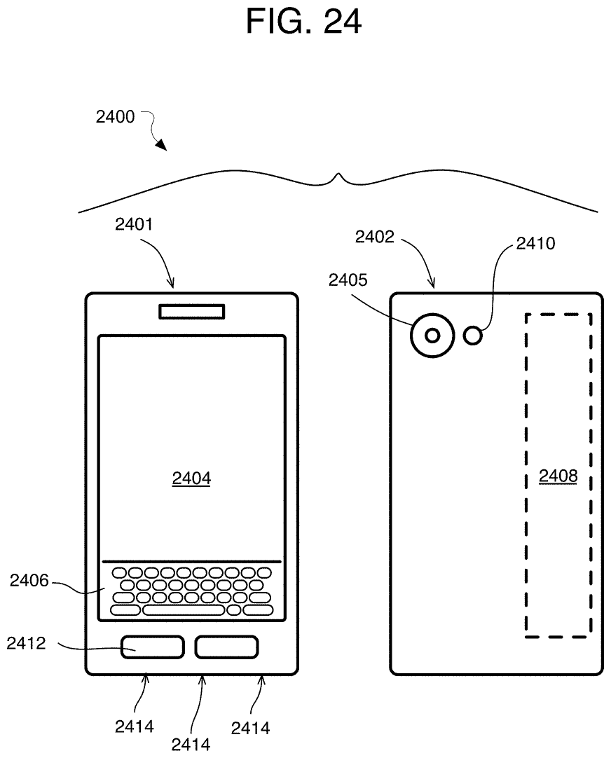

Referring to FIG. 24, a small form factor device 2400 is one example of the varying physical styles or form factors in which systems 2200 or 2300 may be embodied. By this approach, device 2400 may be implemented as a mobile computing device having wireless capabilities. A mobile computing device may refer to any device having a processing system and a mobile power source or supply, such as one or more batteries, for example.

As described above, examples of a mobile computing device may include any device with an audio sub-system such as a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, speaker system, microphone system or network, and so forth, and any other on-board (such as on a vehicle), or building, computer that may accept audio commands.

Examples of a mobile computing device also may include computers that are arranged to be worn by a person, such as a wrist computers, finger computers, ring computers, eyeglass computers, belt-clip computers, arm-band computers, shoe computers, clothing computers, and other wearable computers. In various implementations, for example, a mobile computing device may be implemented as a smart phone capable of executing computer applications, as well as voice communications and/or data communications. Although some implementations may be described with a mobile computing device implemented as a smart phone by way of example, it may be appreciated that other implementations may be implemented using other wireless mobile computing devices as well. The implementations are not limited in this context.

As shown in FIG. 24, device 2400 may include a housing with a front 2401 and a back 2402. Device 2400 includes a display 2404, an input/output (I/O) device 2406, and an integrated antenna 2408. Device 2400 also may include navigation features 2412. I/O device 2406 may include any suitable I/O device for entering information into a mobile computing device. Examples for I/O device 2406 may include an alphanumeric keyboard, a numeric keypad, a touch pad, input keys, buttons, switches, microphones, speakers, voice recognition device and software, and so forth. Information also may be entered into device 2400 by way of microphones 2414 of a microphone array. As shown, device 2400 may include a camera 2405 (e.g., including a lens, an aperture, and an imaging sensor) and a flash 2410 integrated into back 2402 (or elsewhere) of device 2400.

Various implementations may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), fixed function hardware, field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an implementation is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one implementation may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to additional implementations.

By an example one or more first implementations, a computer-implemented method of audio processing comprising: receiving, by at least one processor, audio signals from a microphone array, wherein the audio signals are based on audio emitted from a source; and determining a direction the source is aiming or not aiming the audio and relative to a position of the array by using a version of the audio signals.

By one or more second implementations, and further to the first implementation, wherein the determining comprises determining whether or not the source is aiming the audio at the position of the array.

By one or more third implementations, and further to the first or second implementation, wherein the method comprising wherein the determining comprises determining an angle of the direction relative to the position of the array.

By one or more fourth implementations, and further to any of the first to third implementation, wherein the source is a person emitting sounds from their mouth so that the direction extends outward from the person and in a direction the person is facing.

By one or more fifth implementations, and further to any of the first to fourth implementation, wherein the determining comprises determining that the direction is different than an angle of arrival generally along a straight line from the source to the array.

By one or more sixth implementations, and further to any of the first to fifth implementation, wherein the method comprising extracting features from the audio signals comprising generating feature vectors.

By one or more seventh implementations, and further to the sixth implementation, wherein the method comprising classifying the features to determine the direction.

By one or more eighth implementations, and further to the sixth or seventh implementation, wherein the method comprising inputting the feature vectors into a neural network to output an indicator that indicates whether the direction extends towards a general direction of the array or a different direction.

By one or more ninth implementations, and further to any one of the sixth to eighth implementation, wherein the method comprising inputting the feature vectors into a neural network to output one or more indicators that indicate a likelihood of at least one angle of the direction relative to a reference line extending from the position of the array.

By an example one or more tenth implementations, at least one non-transitory computer-readable medium comprising a plurality of instructions that in response to being executed, causes a computing device to operate by: receiving, by at least one processor, audio signals from a microphone array, wherein the audio signals are based on audio emitted from a source; and determining a direction the source is aiming or not aiming the audio and relative to a position of the array by using a version of the audio signals.

By one or more eleventh implementations, and further to the tenth implementation, wherein the instructions cause the computing device to operate by extracting features from the audio signals comprising comparing a version of the audio signals from multiple pairs of microphones forming the array to generate a comparison value of each comparison.

By one or more twelfth implementations, and further to the eleventh implementation, wherein the instructions cause the computing device to operate by comparing root mean square values of a sample of a duration of an audio signal from individual microphones to form the comparison value.

By one or more thirteenth implementations, and further to the twelfth implementation, wherein the comparison value is a difference of the root mean square values.

By one or more fourteenth implementations, and further to any one of the eleventh to thirteenth implementation, wherein a comparison value is generated for every possible pair of microphones of the array.

By one or more fifteenth implementations, and further to any of the eleventh to fourteenth implementation, wherein the instructions cause the computing device to operate by concatenating the comparison values into feature vectors.

By one or more sixteenth implementations, a computer-implemented system comprising: a microphone array to provide audio signals based on audio emitted from a source; memory communicatively coupled to the array; and processor circuitry forming at least one processor communicatively connected to the array and the memory, the at least one processor being arranged to operate by determining a direction the source is aiming or not aiming the audio and relative to a position of the array by using a version of the audio signals.

By one or more seventeenth implementations, and further to the sixteenth implementation, wherein the audio signals are audio intensity levels and the amplitudes of the audio signals in the time domain are used to determine the direction.

By one or more eighteenth implementations, and further to the sixteenth or seventeenth implementation, wherein the at least one processor is arranged to operate by extracting features from the audio signals comprising comparing a version of the audio signals from multiple pairs of microphones forming the array to generate a comparison value of each comparison.

By one or more nineteenth implementations, and further to any of the eighteenth implementation, wherein the array is a circular array and the comparison value is generated only for each pair of microphones on, or nearest to, radially opposite ends of the array.

By one or more twentieth implementations, and further to the eighteenth implementation, wherein the array is a circular array and a comparison value is generated for all possible pairs of microphones on the array including with a center microphone on the array.

By one or more twenty-first implementations, and further to any one of the sixteenth to nineteenth implementation, wherein the determining comprises inputting features extracted from the audio signals into a neural network that outputs one of: (1) an indicator that indicates whether or not the source is facing the array, (2) one or more indicators that indicate an angle of the direction relative to a reference line from a position of the array, and (3) both (1) and (2).

By an example one or more twenty-second implementations, an audio listening device comprising: a microphone array to provide audio signals based on audio emitted from a source; memory communicatively coupled to the array; and processor circuitry forming at least one processor communicatively connected to the array and the memory, the at least one processor being arranged to operate by determining a direction the source is intentionally aiming or not aiming the audio and relative to a position of the array by using a version of the audio signals.

By one or more twenty-third implementations, and further to the twenty-second implementation, wherein the at least one processor is arranged to operate by extracting features at least partly based on the audio signals and inputting the features into a machine learning algorithm to determine the direction.

By one or more twenty-fourth implementations, and further to any of the twenty-second to twenty-third implementation, wherein the at least one processor is arranged to operate by extracting features from the audio signals comprising comparing a version of the audio signals from multiple pairs of microphones forming the array to generate a comparison value of each comparison, and wherein pairs are selected to generate the comparison values depending on an angle of arrival direction between the source and the array and relative to the microphones forming the pairs.

By one or more twenty-fifth implementations, and further to any of the twenty-second to twenty-fourth implementation, wherein the array has three microphones arranged in a triangle.

In one or more twenty-sixth implementations, a device or system includes a memory and processor circuitry forming a processor to perform a method according to any one of the above implementations.

In one or more twenty-seventh implementations, at least one machine readable medium includes a plurality of instructions that in response to being executed on a computing device, cause the computing device to perform a method according to any one of the above implementations.

In one or more twenty-eighth implementations, an apparatus may include means for performing a method according to any one of the above implementations.

In a further example, at least one machine readable medium may include a plurality of instructions that in response to being executed on a computing device, causes the computing device to perform the method according to any one of the above examples.

In a still further example, an apparatus may include means for performing the methods according to any one of the above examples.

The above examples may include specific combination of features. However, the above examples are not limited in this regard and, in various implementations, the above examples may include undertaking only a subset of such features, undertaking a different order of such features, undertaking a different combination of such features, and/or undertaking additional features than those features explicitly listed. For example, all features described with respect to any example methods herein may be implemented with respect to any example apparatus, example systems, and/or example articles, and vice versa.

What is claimed is:

1. A computer-implemented method of audio processing comprising:
receiving, by at least one processor, audio signals from a microphone array, wherein the audio signals are based on audio emitted from a source; and
determining a direction the source is aiming or not aiming the audio and relative to a position of the array by using a version of the audio signals.

2. The method of claim 1 wherein the determining comprises determining whether or not the source is aiming the audio at the position of the array.

3. The method of claim 1 wherein the determining comprises determining an angle of the direction relative to the position of the array.

4. The method of claim 1 wherein the source is a person emitting sounds from their mouth so that the direction extends outward from the person and in a direction the person is facing.

5. The method of claim 1 wherein the determining comprises determining that the direction is different than an angle of arrival generally along a straight line from the source to the array.

6. The method of claim 1 comprising extracting features from the audio signals comprising generating feature vectors.

7. The method of claim 6 comprising classifying the features to determine the direction.

8. The method of claim 6 comprising inputting the feature vectors into a neural network to output an indicator that indicates whether the direction extends towards a general direction of the array or a different direction.

9. The method of claim 6 comprising inputting the feature vectors into a neural network to output one or more indicators that indicate a likelihood of at least one angle of the direction relative to a reference line extending from the position of the array.

10. At least one non-transitory computer readable medium comprising a plurality of instructions that in response to being executed on a computing device, causes the computing device to operate by:
receiving, by at least one processor, audio signals from a microphone array, wherein the audio signals are based on audio emitted from a source; and
determining a direction the source is aiming or not aiming the audio and relative to a position of the array by using a version of the audio signals.

11. The medium of claim 10 comprising extracting features from the audio signals comprising comparing a version of the audio signals from multiple pairs of microphones forming the array to generate a comparison value of each comparison.

12. The medium of claim 11 comprising comparing root mean square values of a sample of a duration of an audio signal from individual microphones to form a comparison value.

13. The medium of claim 12 wherein the comparison value is a difference of the root mean square values.

14. The medium of claim 11 wherein a comparison value is generated for every possible pair of microphones of the array.

15. The medium of claim 11 comprising concatenating the comparison values into feature vectors.

16. A computer-implemented system comprising:
a microphone array to provide audio signals based on audio emitted from a source;
memory communicatively coupled to the array; and
processor circuitry forming at least one processor communicatively connected to the array and the memory, the at least one processor being arranged to operate by determining a direction the source is aiming or not aiming the audio and relative to a position of the array by using a version of the audio signals.

17. The system of claim 16 wherein the audio signals are audio intensity levels and the amplitudes of the audio signals in the time domain are used to determine the direction.

18. The system of claim 16 wherein the at least one processor is arranged to operate by extracting features from the audio signals comprising comparing a version of the audio signals from multiple pairs of microphones forming the array to generate a comparison value of each comparison.

19. The system of claim 18 wherein the array is a circular array and a comparison value is generated only for each pair of microphones on, or nearest to, radially opposite ends of the array.

20. The system of claim 18 wherein the array is a circular array and a comparison value is generated for all possible pairs of microphones on the array including with a center microphone on the array.

21. The system of claim 16 wherein the determining comprises inputting features extracted from the audio signals into a neural network that outputs one of: (1) an indicator that indicates whether or not the source is facing the array, (2) one or more indicators that indicate an angle of the direction relative to a reference line from a position of the array, and (3) both (1) and (2).

22. An audio listening device comprising:
a microphone array to provide audio signals based on audio emitted from a source;
memory communicatively coupled to the array; and
processor circuitry forming at least one processor communicatively connected to the array and the memory, the at least one processor being arranged to operate by determining a direction the source is intentionally aiming or not aiming the audio and relative to a position of the array by using a version of the audio signals.

23. The device of claim 22 wherein the at least one processor is arranged to operate by extracting features at least partly based on the audio signals and inputting the features into a machine learning algorithm to determine the direction.

24. The device of claim 23 wherein the at least one processor is arranged to operate by extracting features from the audio signals comprising comparing a version of the audio signals from multiple pairs of microphones forming the array to generate a comparison value of each comparison, and wherein pairs are selected to generate the comparison values depending on an angle of arrival direction between the source and the array and relative to the microphones forming the pairs.

25. The device of claim 22 wherein the array has three microphones arranged in a triangle.
